(19) United States
(12) Patent Application Publication
(10) Pub. No.: US 2009/0265993 A1
(43) Pub. Date: Oct. 29, 2009

(54) INTEGRATED WINDOW REGULATOR ASSEMBLY

(76) Inventors: Favad Shah, Clinton TwP, MI (US); Kevin Koneval, Macomb Twp, MI (US)

Correspondence Address: Brinks Hofer Gilson & Lione/Ann Arbor, 524 South Main Street, Suite 200, Ann Arbor, MI, 48104, US

(21) Appl. No.: 12/108,095

(22) Filed: Apr. 23, 2008

(51) Int. Cl. E05F 11/48; B60J 1/08

(52) U.S. Cl. 49/352; 49/502

(57) ABSTRACT

A window regulator assembly is described that comprises a window having a rear, front, bottom, and top edge, front and rear window run channels in which the rear and front window edges reversibly move, a plurality of carrier plates in contact with the bottom edge of the window, a plurality of pulleys, a plurality of pulley attachments, a cable wire, and a drive unit. Many of the components of the window regulator assembly may be formed from a thermoplastic material.

### FIELD OF THE INVENTION

This disclosure relates to a component for automobiles and particularly to a window regulator assembly used to open and close a window in a side door module.

### BACKGROUND OF THE INVENTION

Motor vehicles generally feature side door windows which can be moved between lower (opened) and upper (closed) positions. The mechanism used to move the window between these upper and the lower positions is generally known as a window regulator. A window regulator can either be manually operated by a person or driven by a powered actuator, most commonly an electric motor. One type of window regulator utilizes a pulley system. This pulley system uses a metal cable wrapped around a drum coupled to an electric motor or hand crank to drive a carrier that is fastened to the window and engages a guide rail to control motion as the carrier moves vertically.

Conventional window regulator assemblies may be categorized into either dual rail or single rail configurations. In a dual rail configuration, a pair of separated rails is provided in which each rail includes a clamp fastened to the lower edge of the window. These clamps are then moved in a synchronized manner to raise and lower the window. In a single rail configuration, a single rail is positioned near the center of the window with a clamp fastened at the lower edge of the window. The clamp is then moved vertically along the rail between the open and closed positions. A single rail configuration provides a window regulator assembly with fewer parts than a dual rail configuration. However, the single rail configuration poses a design challenge in providing sufficient stability to control the window's motion. In both the single rail and dual rail configurations, the front and rear edges of the window are retained by and move within a corresponding front and rear window run channel.

Design engineers and manufacturers of automotive components are continuously striving to reduce their cost, complexity, and weight in order to provide features and functions for motor vehicles at minimum cost. In one type of existing single rail configuration, a window clamp is made from stamped sheet metal. This sheet metal part is formed to span across the guide rail in order to adequately engage the rail and to include enough space to mount a pair of separated clamps that fasten to the lower or bottom edge of the window. This large sheet metal stamping is a relatively heavy and expensive component to fabricate.

Therefore, improved regulator assemblies that are relatively light-weight and inexpensive to manufacture are continuously desired. It is also desirable to reduce the complexity of the regulator assembly, thereby, simplifying both the manufacturing and operation of the assembly.

### SUMMARY OF THE INVENTION

One form of the present disclosure is to provide an improved regulator assembly that can be substantially formed from injection molded plastic resins and to which other components may be added in a manner that provides a cost effective and functional assembly.

A window regulator assembly is described that comprises a window having rear, front, bottom, and top edges; multiple window run channels in which the rear and front window edges reversibly move; a plurality of carrier plates in contact with the bottom edge of the window; a plurality of pulleys, pulley shafts, and pulley attachments; a cable wire; and a drive unit. The pulley attachments may be integrally connected to the window run channel.

In one form of the disclosure, the pulleys and window run channels may be attached to the inner door panel through a threaded shaft and a fastener in order to address exposure to high load forces. The pulleys may be attached to the window run channels via pulley attachments, though the use of a snap-fit fixture, or by welding. The drive unit in the window regulator assembly may be a manually operated hand crank or an automatic actuator, such as an electric motor. The drive unit may be supported by attachment to the door panel.

In the window regulator assembly, a plurality of cable guides may be used to maintain predetermined angles between the cable wire and the pulley and between the cable wire and carrier plate. These cable guides may be integrally formed with the window run channels or snapped in place. Due to possible obstruction with other components in the door module, the cable may also be routed through a conduit.

The present disclosure provides a means through which the weight and cost of the window regulator assembly may be reduced. Various components of the window regulator system, such as the window run channels, carrier plates, pulleys, pulley shafts, and pulley attachments, as well as any gears in the drive unit may be formed from a thermoplastic material. The thermoplastic material may be formed into the component through injection molding, thermoforming, extrusion, or any other means known to one skilled-in-the-art. When desirable these same components may be formed from metal and welded or attached within the door module.

Further areas of applicability will become apparent from the description provided herein. It should be understood that the description and any specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side cut-away view of the interior of a motor vehicle door module showing a movable door window and a window regulator assembly including features in accordance with this disclosure;

FIG. 2 is a perspective view of the components of a window regulator assembly in accordance with this disclosure with the window in the down position;

FIG. 3A is a cross-sectional view taken along line A-A from FIG. 2;

FIG. 3B is a cross-sectional view taken along line B-B from FIG. 2;

FIG. 3C is a cross-sectional view taken along line C-C from FIG. 2; and

FIG. 4 is a perspective view of another form for a pulley and pulley attachment of the present disclosure.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

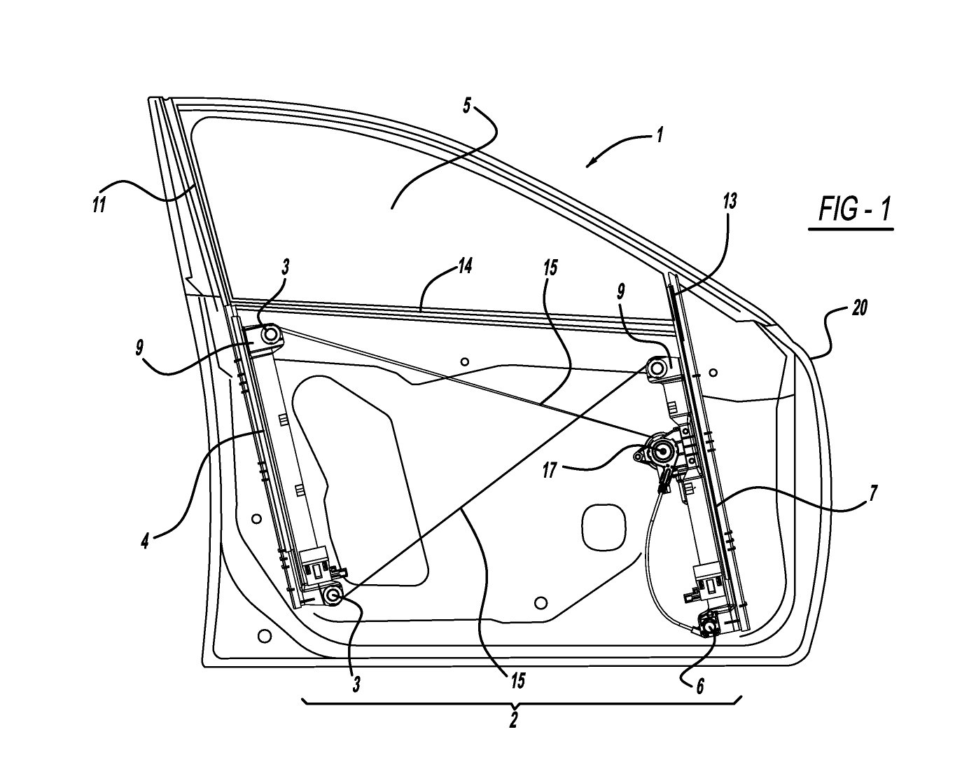

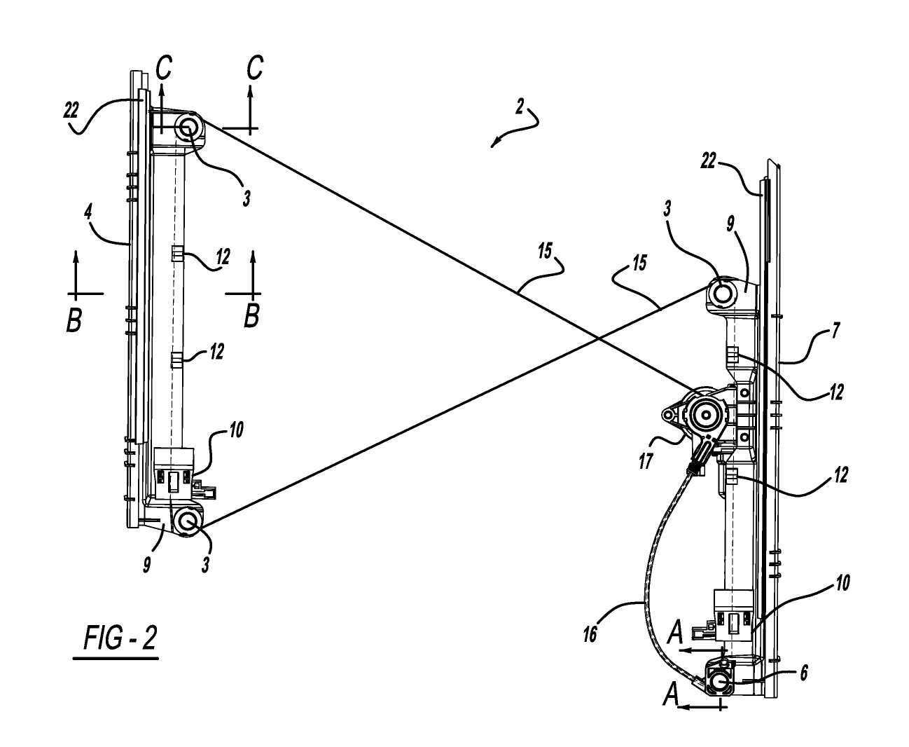

In FIG. 1 a side cut-away view of an automotive door module 1 is shown revealing a side movable door window 5 and a portion of the window regulator assembly 2 positioned within the confines of the outer door panel 20. The window regulator assembly 2 shown in FIG. 1 includes a front window run channel 7, a rear window run channel 4, and various other components, such as pulleys 3, a drive unit 17, cable wire 15, and pulley attachments 9. Additional elements of the window regulator assembly 2 that are necessary to make it fully functional, including but not limited to carrier plates 10, are more adequately represented in FIG. 2. FIG. 1 illustrates the door window 5 in a raised or closed position. The vertical motion of the window is guided by front 7 and rear 4 window run channels that interact with the rear edge 11 and front edge 13 of the window 5. In the fully raised or closed position, the window 5 may be sealed within the frame of the door module 1.

The window 5 may be formed from glass, a thermoplastic resin, or any other substantially transparent glazing material known to someone skilled-in-the-art. Examples of thermoplastic resins suitable for use as a window 5 include, but are not limited to, polycarbonate, acrylic resins, polyarylate resins, polyester resins, and polysulfone resins.

Now with reference to FIG. 2, greater details related to various components of the window regulator assembly 2, such as front 7 and rear 4 window run channels, carrier plates 10, pulleys 3, cable 15, pulley attachments 9, lower guide 6, conduit 16, drive unit 17, and cable guides 12 are shown. The front 7 and rear 4 window run channels are used as a guide for the movement of the window between open and closed positions, thereby, eliminating the need for a separate guide rail as found in a conventional window regulator assembly. The outer door panel 20 is formed in a manner that establishes a surface upon which the rear 4 and front 7 window run channels may be attached. The front run channel 7, which is closest to the “A” pillar of the vehicle, may also be attached at the standard mirror patch position well known to someone skilled-in-the-art.

The front 7 and rear 4 window run channels are preferably formed from a thermoplastic material in order to reduce weight and to simplify integration with and provide support for other components in the window regulator assembly. Examples of thermoplastic materials suitable for use as a window run channel include, but are not limited to, polyamides, polyalkyene terephthalates, polycarbonates, polyurethanes, acrylonitrile butadiene styrene (ABS), polyesters, nylon, polyoxymethylene (POM), nylon, polypropylene, and mixtures or blends thereof. For strength and reinforcement the thermoplastic materials may incorporate fillers, such as but not limited to long glass fibers (LGF), glass particles, carbon black, and silica. One skilled-in-the-art will recognize that other materials including conventional metal may be used to form the window run channels. The run channels may be attached, fastened, or welded to the outer door panel 20.

The carrier plate 10 shown in FIG. 2 makes contact with and may be attached to or formed with the bottom edge 14 of a window 5 in close proximity to the rear edge 11 or front edge 13 of the window 5 (as shown in FIG. 1). If desired the carrier plate 10 may be formed with or attached to the lower portion of the rear edge 11 or front edge 13 of the window 5. Each carrier plate 10 is attached or connected to the cable wire 15. Such attachment or connection may be made through the use of clamps, fasteners, adhesives, press fittings, snap fittings, or any other means known to one skilled-in-the-art. The cable wire 15 may include a nipple end (not shown) that may be attached, clamped, or fastened to the carrier plate 10. One example of a carrier plate is shown as part of the window clamp assembly described in U.S. patent application Ser. No. 11/784,595 filed on Apr. 9, 2007, which is hereby incorporated by reference in its entirety. The carrier plate 10 of the present disclosure may be free “floating” in that it may interact with but not be attached to the window run channel 7. Preferably there is at least one carrier plate 10 to interact with each window run channel 4 & 7. The carrier plate 10 may include one or more springs (not shown) to help keep the window regulator assembly 2 under tension.

As shown in FIG. 2, the window regulator assembly 2 also includes a drive unit or motor 17, a cable wire 15, a plurality of pulleys 3, and multiple pulley attachments 9. The drive unit 17 may be manually operated via a hand crank mechanism or powered, most commonly done using an electric motor attached to a set of gears, such as worm and spur gears. The drive unit 17 interacts with the cable wire 15 to provide the cable tension necessary to cause the carrier plates 10 and the window 5 to move between its open and closed positions. The drive unit 17 may be supported by attachment to the inner door panel 19 or outer door panel 20.

Continuing with FIG. 2, the pulleys 3 and lower guide 6 interact with and are used to guide the movement of the cable wire 15. Each pulley 3 may be connected through a pulley attachment 9 to the window run channel 7 through the use of a pulley shaft 21. The pulley attachment 9 may be integrally formed with, fastened, to, or welded to the window run channel 7. At least two pulleys 3, or one pulley 3 and one lower guide 6, are associated with each window run channel 4 & 7. Since the pulleys 3 may be exposed to a high force loading, the pulleys 3 and lower guide 6 may be attached to the inner door panel 19.

Due to an obstruction from another component in the door module 1, it may be desirable in certain instances to alter the routing of the cable wire 15 through the use of a conduit 16. Such conduit 16 may be any flexible non-metallic or metallic sheath known to one skilled-in-the-art. The sheath may be further reinforced with a wound plastic spiral spring, metal wire, or any other type of reinforcement. A conduit can be used in conjunction with the cable wire 15 and any pulley 3 as deemed desirable. For example, in FIG. 2 a conduit 16 is shown in use between a lower guide 6 and the drive unit 17.

The window regulator assembly 2 may also utilize a cable guide 12 to protect the cable wire 15 along the length of the window run channels 4 & 7. Cable guides 12 may be integrally formed with the window run channels 4 & 7 or be a separate assembly. The purpose of the cable guide 12 is to maintain predetermined angles between the cable wire 15 and the pulleys 3, as well as between the cable wire 15 and the carrier plates 10. The window regulator assembly 2 may include a plurality of cable guides 12. A cable guide 12 may make contact with the window run channels 4 & 7 through a snap-on fastener or clip.

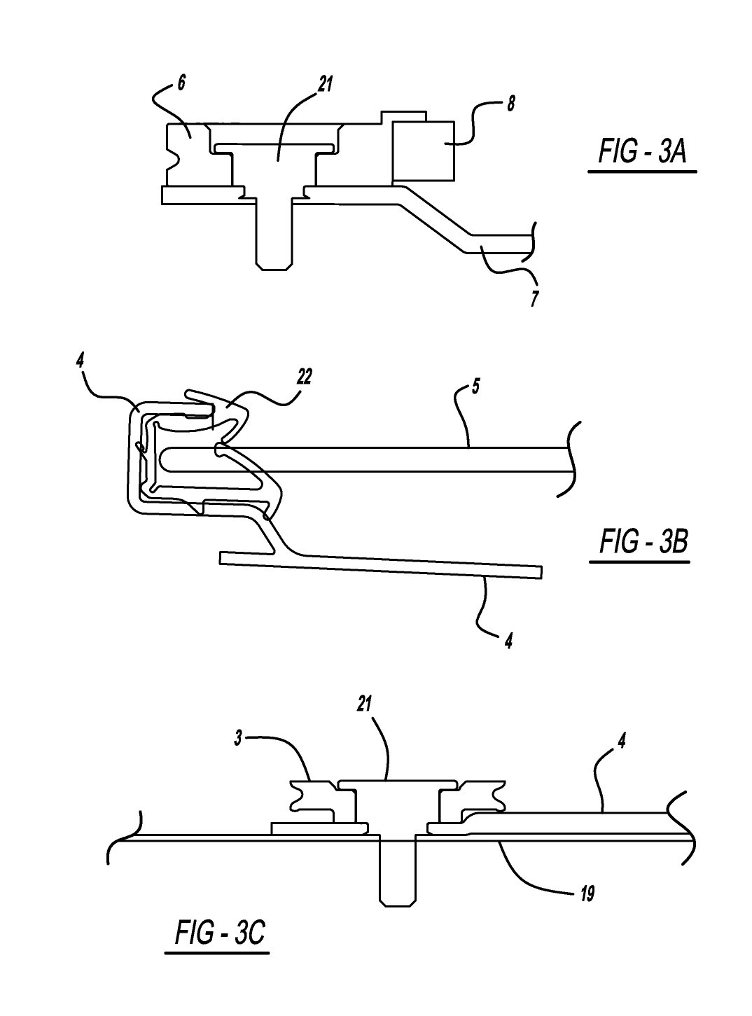

In FIG. 3A, a cross sectional view taken along line A-A is shown with respect to a lower guide 6, a window run channel 7, and the inner door panel 19. The lower guide 6 and window run channels 4 & 7 may be attached to the inner door panel via a pulley shaft 21 and a fastener (not shown). One example of a means of attachment involves the pulley shaft 21 being threaded and the fastener being a threaded nut. However, any other means of attachment known to one skilled-in-the-art is possible. A window stop 8 may also be incorporated along with the lower guide 6. The movement of the carrier plate 10 comes to a stop upon interaction with the window stop 8 when the window is in a full open position. The window stop 8 may be integrally formed with, fastened, attached, or welded to a window run channel 4 or 7, inner door panel 19, or outer door panel 20.

In FIG. 3B, a cross-sectional view taken along line B-B is shown with respect to the window run channel 4 and the window 5. The window run channels 4 & 7 may include a weather strip 22 that will interact with the window 5 when the window is in its closed position to provide a weatherable seal.

In FIG. 3C, a cross sectional view taken along line C-C is shown with respect to an upper pulley 3, a window run channel 4, and the inner door panel 19. The pulley may be attached to the inner door panel via a pulley shaft 21 and a fastener (not shown). One example of a means of attachment involves the pulley shaft 21 being threaded and the fastener being a threaded nut. However, any other means of attachment known to one skilled-in-the-art is possible.

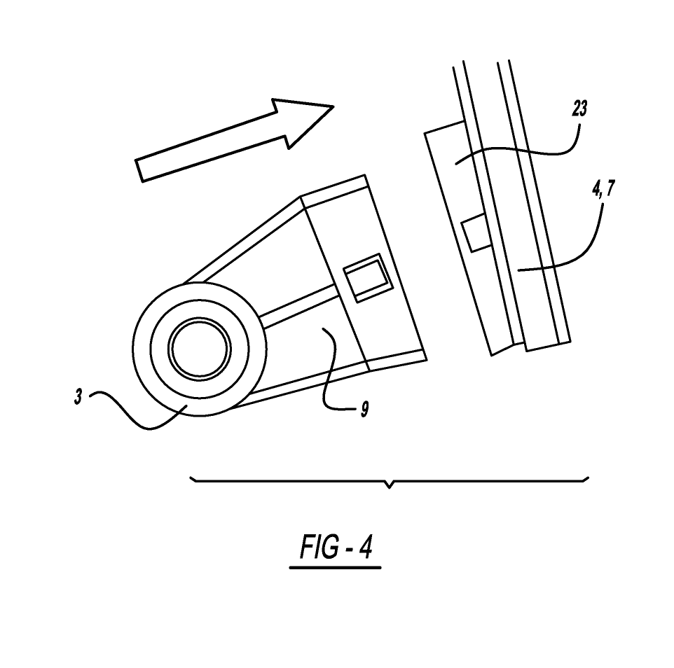

In FIG. 4, another form of the pulley attachment 9 of the present disclosure is shown. The pulley attachment 9 may be a snap fit bracket that can be attached to a complimentary fixture 23 either integrally formed with or welded to a window run channel 4 & 7.

The pulleys 3 and their corresponding pulley shafts 21, as well as pulley attachments 9, cable guides 12, carrier plates 10 and other components, including but not limited to, the gears in the drive unit 17, may be formed from a thermoplastic material or a metal. Examples of thermoplastic materials suitable for use include, but are not limited to, polyamides, polyalkyene terephthalates, polycarbonates, polyurethanes, acrylonitrile butadiene styrene (ABS), polyesters, nylon, polyoxymethylene (POM), nylon, polypropylene, and mixtures or blends thereof. For strength and reinforcement the thermoplastic materials may incorporate fillers, such as but limited to long glass fibers (LGF), glass particles, carbon black, and silica. One skilled-in-the-art will recognize that other materials may also be used, such as conventional metals.

Thermoplastic materials may be formed into the components described above using any technique known to one skilled-in-the-art. Examples of suitable techniques include, but are not limited to, injection molding, thermoforming, and extrusion. Metals may be formed into the components described above, as well as the window run channels, using any technique known to one skilled-in-the-art, including but not limited to, roll forming, forging, extrusion & drawing, sheet metal forming, and powder metallurgy.

A person skilled in the art will recognize from the previous description that modifications and changes can be made to the present disclosure without departing from the scope of the disclosure as defined in the following claims.

What is claimed is:

1. A window regulator assembly for moving a window between opened and closed positions in a vehicle door module having an inner and outer door panel, the window regulator assembly comprising:
a window having a front edge, a rear edge, a top edge, and a bottom edge;
a front window run channel in which the front window edge may reversibly move;
a rear window run channel in which the rear window edge may reversibly move;
at least two carrier plates in contact with the bottom window edge with at least one of the carrier plates positioned in close proximity to the front window edge and at least one of the carrier plates positioned in close proximity to the rear window edge; and
a plurality of pulleys, a plurality of pulley attachments, a lower guide, a cable wire, and a drive unit that interact with the window run channels to move the window between open and closed positions.

2. The window regulator assembly of claim 1, further comprising a plurality of cable guides.

3. The window regulator assembly of claim 1, wherein the drive unit is in close proximity to one window run channel and is attached to either the inner or outer door panel.

4. The window regulator assembly of claim 1, wherein the cable wire is attached to the carrier plates using a means selected from clamps, fasteners, adhesives, press fittings, or snap fittings.

5. The window regulator assembly of claim 1, wherein a portion of the cable wire resides within a conduit.

6. The window regulator assembly of claim 5, wherein the conduit is located between the lower guide and the drive unit.

7. The window regulator assembly of claim 1, wherein the pulley attachments are integrally formed with, fastened, or welded to at least one window run channel.

8. The window regulator assembly of claim 1, wherein the pulley attachments are snap-fit to a complimentary fixture, integrally formed with, fastened, or welded to at least one window run channel.

9. The window regulator assembly of claim 1, wherein the pulley attachments are located adjacent to at least one window run channel.

10. The window regulator assembly of claim 1, wherein the window run channel is attached to the outer door panel.

11. The window regulator assembly of claim 1 wherein the pulleys are fastened to the inner door panel through a pulley shaft.

12. The window regulator assembly of claim 11, wherein the pulley shaft is threaded.

13. The window regulator assembly of claim 1, wherein a carrier plate uses at least one spring to maintain tension in the assembly.

14. The window regulator assembly of claim 2, wherein the cable guides are integrally formed with, fastened, or welded to the window run channel.

15. The window regulator assembly of claim 14, wherein the cable guides maintain a predetermined angle between the cable wire and the carrier plates.

16. The window regulator assembly of claim 14, wherein the cable guides make contact with the cable wire through a snap-on fastener.

17. The window regulator assembly of claim 1 wherein the window run channels, carrier plates, pulley attachments, lower guide, or pulleys are formed from a thermoplastic material or a metal.

18. The window regulator assembly of claim 2, wherein the cable guides are formed form a thermoplastic material or a metal.

19. The window regulator assembly of claims 17, wherein the thermoplastic material is formed into the window run channels, carrier plates, pulley attachments, lower guide, or pulleys using an injection molding, thermoforming, or extrusion process.

20. The window regulator assembly of claims 17, wherein the metal is formed into the window run channels, carrier plates, pulley attachments, lower guide, or pulleys using roll forming, forging, extrusion & drawing, sheet metal forming, or a powder metallurgy process.

21. The window regulator assembly of claim 1, wherein the window is formed from glass or a thermoplastic material.

22. The window regulator assembly of claim 1, wherein the motion of the carrier plate is halted upon contact with a window stop.

23. A window regulator assembly for moving a window between opened and closed positions in a vehicle door module having an exterior and interior door panel, the window regulator assembly comprising:
a window having a front edge, a rear edge, a top edge, and a bottom edge;
a front window run channel attached to the outer door panel in which the front window edge may reversibly move;
a rear window run channel attached to the outer door panel in which the rear window edge may reversibly move;
at least two carrier plates in contact with the bottom window edge and positioned in close proximity to the front and rear window edges;
two upper pulleys, a lower pulley, and a lower guide in close proximity to a window run channel and attached to the inner door panel,
a drive unit in close proximity to a window run channel and attached to one of the inner or outer door panel;
a plurality of pulley attachments connecting each pulley and the lower guide to a window run channel; and
a cable wire attached to the carrier plates;
wherein the interaction between the pulleys, the lower guide, the cable wire, the carrier plates, and a drive unit with the window run channels moves the window between open and closed positions.

24. The window regulator assembly of claim 23, wherein the cable wire is attached to the carrier plates using a means selected from clamps, fasteners, adhesives, press fittings, or snap fittings.

25. The window regulator assembly of claim 23, wherein the pulley attachments are integrally formed with, fastened, or welded to one of the window run channels.

26. The window regulator assembly of claim 23, wherein the pulley attachments are snap-fit to a complimentary fixture, integrally formed with, fastened, or welded to one of the window run channels.

27. The window regulator assembly of claim 23, further comprising a plurality of cable guides.

28. The window regulator assembly of claim 27, wherein the cable guides make contact with the cable wire through a snap-on fastener.

29. The window regulator assembly of claim 23 wherein the window run channels, carrier plates, pulley attachments, lower guide, or pulleys are formed from a thermoplastic material or a metal.
